(19) United States
(12) Patent Application Publication
(10) Pub. No.: US 2015/0345762 A1
(43) Pub. Date: Dec. 3, 2015

(54) DIRECTIONAL LIGHTING

(71) Applicant: Cree, Inc., Durham, NC (US)

(72) Inventors: Ethan Creasman, Morrisville, NC (US); Randy Bernard, Cary, NC (US)

(73) Assignee: Cree, Inc., Durham, NC (US)

(21) Appl. No.: 14/287,812

(22) Filed: May 27, 2014

(51) Int. Cl. F21V 21/15; F21V 21/30

(52) U.S. Cl. CPC F21V 21/15; F21V 21/30

(57) ABSTRACT

A lighting fixture is disclosed. In one embodiment, the lighting fixture includes a motorized pan-tilt mechanism having a head unit. The head unit either includes a light source or a receptacle for receiving and powering a light source. The motorized pan-tilt mechanism is capable of moving the head unit to control the direction in which light emitted from the light source is directed.

### FIELD OF THE DISCLOSURE

The present disclosure relates to a lighting fixture and to a system and a remote control for the same.

### BACKGROUND

Directional lighting systems, such as track lighting systems, spot lighting systems, or stage lighting systems, have historically been manually adjusted or directly controlled by a complicated control system. When using a control system, the direction of the emitted light beam for a given lighting fixture may be directly controlled by user inputs to the control system. For example, a user may move a joystick longitudinally or press a button to raise or lower the emitted light beam, or move the joystick laterally or press another button to move the emitted light beam left or right. Alternatively, the lighting fixtures may be controlled based on pre-programmed criteria, such as that used for stage lighting systems, wherein the control system provides instructions to control the lighting fixtures based on pre-programmed criteria. The criteria could be based on scene selections, environmental conditions, and the like. Unfortunately, most remote controllable lighting systems are expensive and generally application specific.

For many environments that employ directional lighting, such as retail, museum, and home environments, manually adjusted directional lighting systems are ubiquitous. However, the lighting systems are generally mounted out of arm's reach from a ceiling or high on a wall, and thus require users to climb ladders to reach and orient each lighting fixture to position the emitted light beam. The use of ladders is both time consuming and dangerous. As such, there is a need for a directional lighting system that allows the user to remotely adjust the direction of the emitted light beam in a safe, efficient, and cost-effective manner.

### SUMMARY

A lighting fixture is disclosed. In one embodiment, the lighting fixture includes a motorized pan-tilt mechanism having a head unit. The head unit either includes a light source or a receptacle for receiving and powering a light source. The motorized pan-tilt mechanism is capable of moving the head unit to control the direction in which light emitted from the light source is directed.

In one embodiment, a control system of the lighting fixture is capable of locating a target based on information received from one or more sensors associated with the lighting fixture. The target may be a projected image or a defined object. For a projected image, a handheld device may be configured to project a target onto a surface to be illuminated by the lighting fixture. For a defined object, the defined object may be held in front of the surface to be illuminated. The defined object may take virtually any form, but may be the handheld device itself in certain embodiments. Once the target is located, the control system moves the head unit such that the light source emits light toward the target.

In particular, the lighting fixture may include a motorized pan-tilt mechanism and a controller. The motorized pan-tilt mechanism has a head unit that includes either a light source or a socket adapted to receive a light source. The motorized pan-tilt mechanism is capable of orienting the head unit to control a direction in which light emitted from the light source is directed. The controller is associated with at least one sensor and the motorized pan-tilt mechanism. For orienting the light source, the controller may be configured to:
receive sensor information from at least one sensor that is in communication with the controller;
identify a target based on sensor information; and
control the motorized pan-tilt mechanism to orient the head unit such that the light emitted from the light source is directed at the target.

In one embodiment, the light source is integrated into the head unit. In another, the light source is a light bulb with a base, and the head unit includes the socket, which is configured to receive the light bulb. The motorized pan-tilt mechanism may also include a base that is coupled to the head unit. The base is configured to control at least panning of the head unit, which is also configured to tilt relative to the base. The at least one sensor may be mounted on any part of the lighting fixture or may be mounted apart from the lighting fixture. In one embodiment, the at least one sensor is mounted on the motorized pan-tilt mechanism and moves in conjunction with either the light source or the socket when the head unit is moved.

For one embodiment, the controller may move the head unit; monitor the sensor information for the target as the head unit is moved; and locate the target in the sensor information. Once the target is identified, the controller may determine an orientation for the head unit such that the light emitted from the light source will be directed at the target based on the sensor information.

In another embodiment, the controller may monitor the sensor information for both the target and the emitted light and then control the motorized pan-tilt mechanism to orient the head unit such that the light emitted from the light source is directed at, or aligns with, the target.

Prior to the orientation process, the controller may be configured to receive selection initiation information from a remote entity, such as the handheld device, and receive selection information indicative of the lighting fixture being selected from the remote entity. The selection initiation information may be received via wired or wireless interface, and may include an identifier of the lighting fixture. The controller may be further configured to provide the identifier of the lighting fixture to the remote entity in response to receiving the selection initiation information.

The controller may be configured to provide human perceptible feedback in response to receiving the selection information. Controlling the light emitted by the light source in a defined manner may provide the human perceptible feedback. The lighting fixture may include an indicator that is separate from the light source, wherein the human perceptible feedback is provided by controlling the indicator in a defined manner. The controller may also be configured to provide human perceptible feedback in response to receiving the selection initiation information.

In an alternative embodiment, the control system determines location information that is associated with a target and moves the head unit based on the location information, such that the light source points toward the target. For example, the handheld device may represent the target and be configured to identify its location relative to the lighting fixture. Once the location is identified, a handheld device may send location information bearing on the identified location to the lighting fixture, which will move the head unit based on the location information, such that the light source emits light toward the target. Alternatively, the handheld device may transmit a signal from which its location may be derived by the lighting fixture.

In particular, the lighting fixture may include a motorized pan-tilt mechanism, a communication interface, and a controller. The motorized pan-tilt mechanism may have a head unit that includes either a light source or a socket adapted to receive a light source, wherein the motorized pan-tilt mechanism is capable of orienting the head unit to control a direction in which light emitted from the light source is directed.

For an orientation process, the controller may be configured to:
receive a signal via the communication interface, the signal bearing on a location associated with a target to be illuminated;
based on the location associated with the target, determine a desired orientation for the head unit wherein the light emitted from the light source is directed toward the target; and
control the motorized pan-tilt mechanism to orient the head unit at the desired orientation.

In one embodiment, the signal includes location information that identifies the location associated with the target, and the controller determines the desired orientation based on the location associated with the target. Alternatively, the controller may derive a location of the target based at least in part on a characteristic of the signal, and determine the desired orientation based on the location associated with the target using triangulation or like methods. The details set forth for the scanning based process are applicable to this location-based configuration.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A through 1C illustrate different stages of orienting a lighting fixture in a museum environment, according to a first embodiment.

FIGS. 2A through 2D illustrate a process for orienting a lighting fixture in the museum environment of FIGS. 1A through 1C.

FIGS. 3A through 3C illustrate different stages of orienting a lighting fixture in a museum environment, according to a second embodiment.

FIGS. 4A through 4D illustrate a process for orienting a lighting fixture in the museum environment of FIGS. 3A through 3C.

FIGS. 5 and 6 are respective isometric and cross-sectional side views of a lighting fixture with an integrated light source, according to one embodiment.

FIG. 7 is a block diagram of the electronics for a lighting fixture according to one embodiment.

FIG. 8 illustrates multiple lighting fixtures that have an integrated lighting source and are mounted on a mounting track, according to one embodiment.

FIGS. 9A and 9B provide a communication flow diagram that illustrates operation of a remote control and multiple lighting fixtures, according to one embodiment.

FIGS. 10 and 11 are respective isometric and side views of a lighting fixture with an integrated light source, according to one embodiment.

FIG. 12 illustrates multiple lighting fixtures that have an integrated lighting source and are mounted on a mounting track, according to one embodiment.

FIG. 13 illustrates multiple lighting fixtures that are adapted to receive light bulbs in respective sockets and are mounted on a mounting track, according to one embodiment.

FIG. 14 illustrates multiple lighting fixtures that have an integrated lighting source and are mounted on a mounting track, according to one embodiment.

FIGS. 15 and 16 are different isometric views of an exemplary remote control, according to one embodiment.

FIG. 17 is a block diagram of the electronics for a remote control, according to one embodiment.

FIG. 18 illustrates multiple lighting fixtures that have an integrated lighting source and are mounted on a mounting track, according to yet another embodiment.

FIG. 19 illustrates multiple lighting fixtures that are adapted to receive light bulbs in respective sockets and are mounted on a mounting track, according to yet another embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

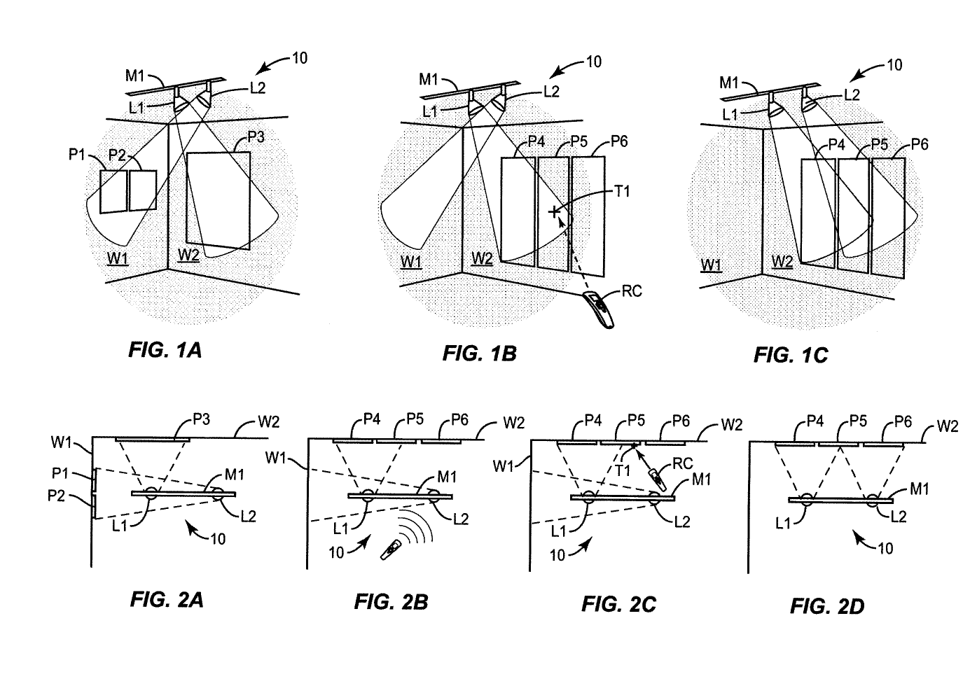

With reference to FIGS. 1A-1C, a lighting environment 10 is illustrated. While the concepts disclosed herein may apply to any type of environment, the exemplary lighting environment 10 that is shown represents a museum environment in which various paintings are distributed along multiple walls. In particular, FIG. 1A illustrates paintings P1 and P2 hung on wall W1, and painting P3 hung on wall W2. The paintings P1-P3 are illuminated by a track lighting system, which includes a lighting fixture L1 and a lighting fixture L2, which are mounted to a mounting track M1 that may be suspended from or mounted directly to a ceiling. As illustrated, lighting fixture L1 is oriented to illuminate painting P3, and lighting fixture L2 is oriented to illuminate paintings P1 and P2.

Assume that the museum curator decides to replace the paintings P1-P3 with paintings P4-P6 and to hang the paintings P4-P6 adjacent one another on wall W2, as illustrated in FIG. 1B. Noticeably, the lighting system needs to be

adjusted to properly illuminate the newly hung paintings P4-P6. Assume that lighting fixture L1 does not need to be reoriented, but lighting fixture L2 does need to be reoriented, as illustrated in FIG. 1C. Prior to the concepts disclosed herein, the curator would have to get a ladder, climb the ladder, and manually adjust the lighting fixture L2 to properly illuminate the paintings P4-P6.

With the concepts disclosed herein, the curator can reorient the lighting fixture L2, along with any other lighting fixture L, through a simple process that is orchestrated with a remote control RC, as shown in FIGS. 2A-2B. FIG. 2A is a top view of the original painting configuration, and FIG. 2B illustrates the updated painting configuration. Once the new paintings P4-P6 are hung, the curator need only wirelessly select the lighting fixture L2 with the remote control RC (FIG. 2B), provide a target T1 at the location to be illuminated with the selected lighting fixture L2 (FIGS. 1B and 2C), and instruct the selected lighting fixture L2 to reorient itself to illuminate the target T1 (FIGS. 1C and 2D). The process may be repeated for the other lighting fixture L1, if so desired.

As illustrated in FIGS. 1B and 2C, the remote control RC may be configured to project the target T1, under the control of the user, onto a location to be illuminated. The projection is analogous to pointing a laser pointer at a desired location. The projected target may range from a simple dot, circle, crosshair pattern (illustrated) or like symbol to a complex image, pattern, or machine readable code, such as a bar code or matrix code. The projected target may be fixed or implemented to change according to a defined pattern. For example, the projected target may blink, rotate though a color pattern or shape pattern, and the like. Further, the projected target may also be projected to have a defined color, color temperature, or the like, which may aid in allowing the lighting fixtures L1, L2 to identify the target. The color or color temperature of the projected target may be the same or different from that of the normally emitted light.

Alternatively, the remote control RC itself or other designated object may act as the target T1, which is recognizable by the lighting fixtures L1, L2. As such, the lighting fixtures L1 or L2 will search for the image of the remote control RC or other designated object and orient itself to illuminate the object. For the above embodiment, the lighting fixtures L1, L2 may include, or otherwise be associated with, an imaging capability that can scan for and identify the target T1 as well as a mechanism that is capable of reorienting the lighting fixtures L1, L2 to illuminate the target T1.

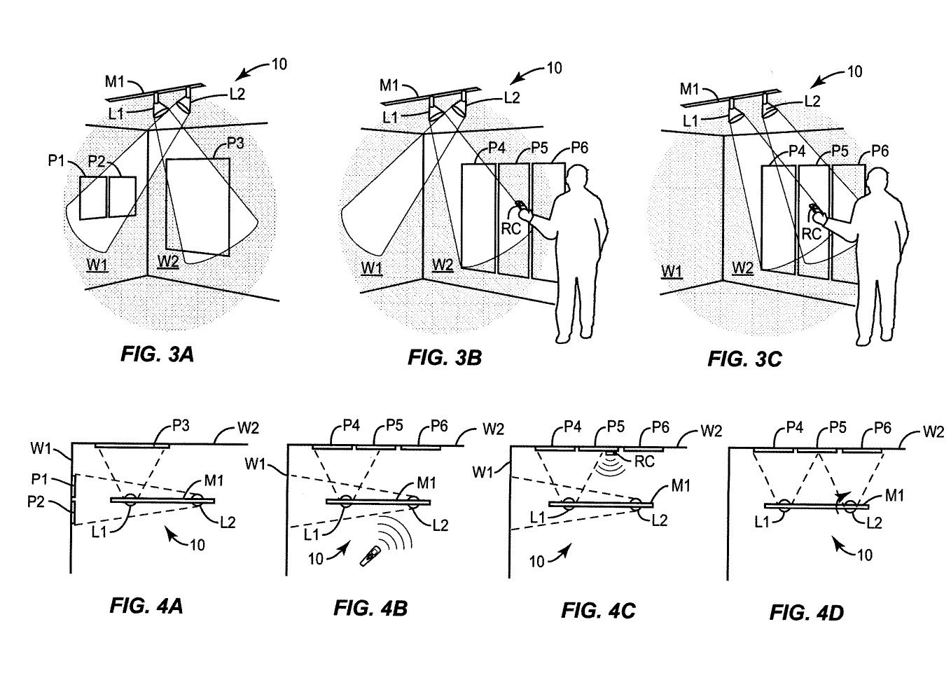

In an alternative embodiment, the remote control RC is capable of emitting a location signal from which the lighting fixtures L1, L2 are able to identify the location of the remote control RC. FIGS. 3A and 4A illustrate the original painting configuration, and FIGS. 3B and 4B illustrate the updated painting configuration, which is the same as the above-described museum example. Once the new paintings P4-P6 are hung, the curator need only select the lighting fixture L2 with the remote control RC (FIG. 4B) and then position the remote control RC at the location to be illuminated (FIGS. 3B and 4C). While holding remote control RC at the location to be illuminated, the user will cause the remote control RC to emit the location signal. The selected lighting fixture L2 receives the location signal, determines the location of the remote control RC based on the location signal, and reorients itself to direct the emitted light toward that location (FIGS. 3C and 4D).

In one configuration, the remote control RC can identify its location and provide location information in the location signal. In another configuration, the location signal may simply be a signal from which the lighting fixtures L1, L2 can individually or collectively process to determine a location of origin through known triangulation techniques and the like. In this latter configuration, the lighting fixtures L1, L2 each receive the location signal and coordinate with one another to triangulate, or otherwise determine, the location of origin. Alternatively, each lighting fixture L1, L2 may need to be associated with multiple receivers, which are spaced apart from one another and capable of receiving the location signal.

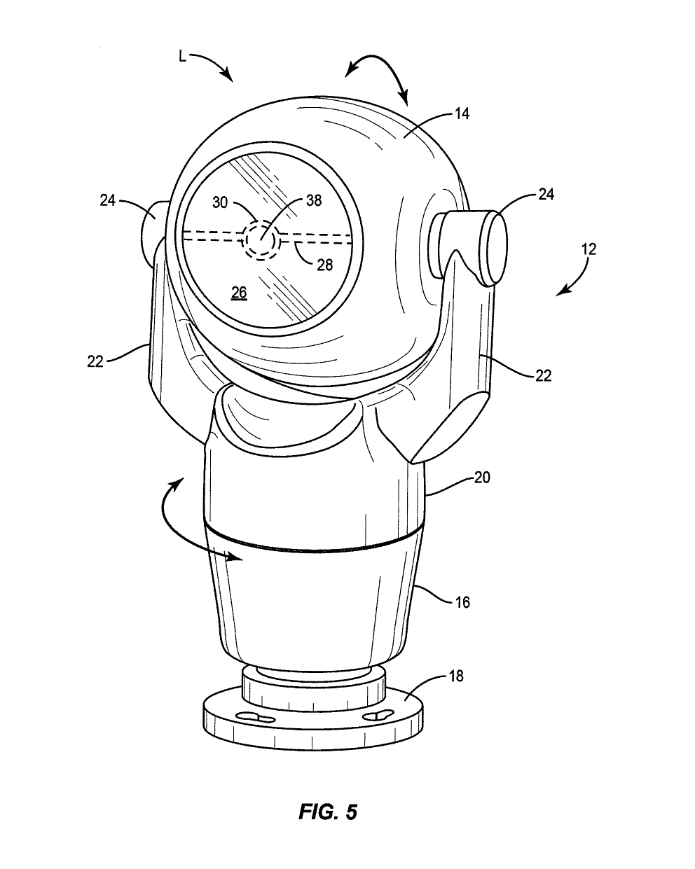

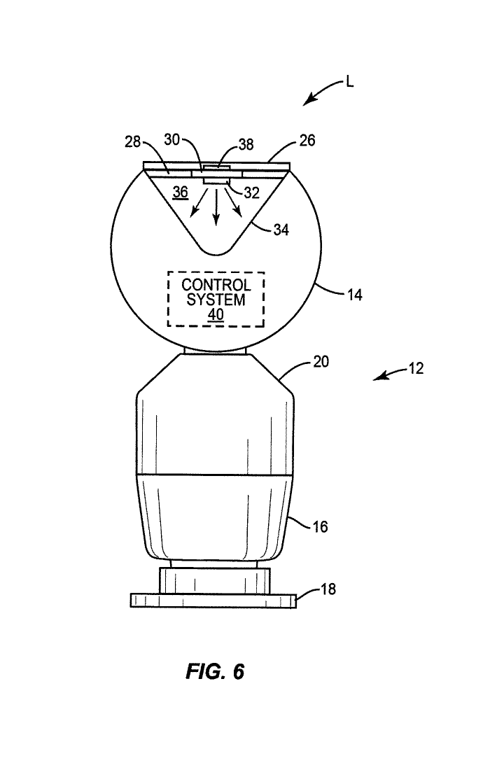

Details about the operation of the above embodiments are provided further below. Prior to delving into these details, an overview of an exemplary lighting fixture L is provided immediately below. Reference is now made to FIGS. 5 and 6. In this example, the lighting fixture L includes a pan-tilt mechanism 12 with a head unit 14. In addition to the head unit 14, the pan-tilt mechanism 12 includes a base 16 with a mounting bracket 18, a pan mechanism 20, multiple arms 22, and a tilt mechanism 24. The base 16 is relatively fixed and attachable to a wall, ceiling, beam, mounting track M1, or any other suitable structure using the mounting bracket 18.

The pan mechanism 20 is coupled to the base 16 and is configured to rotate about a central axis of the base 16 using a servo, stepper motor, or like rotational actuators, and may generally be referred to as being motorized. As illustrated, two arms 22 extend outward from the pan mechanism 20 and terminate at respective tilt mechanisms 24. The head unit 14 is mounted between the tilt mechanisms 24 and is configured to rotate about an axis that extends between the tilt mechanisms 24 using one or more servos, stepper motors, or like rotational actuators, which are mounted either in the head unit 14 or in one or both of the tilt mechanisms 24.

The head unit 14 has an integrated light source in this embodiment. While the light source may be configured in a variety of ways, the light source of FIGS. 5 and 6 is configured as follows. The head unit 14 is substantially spherical with the exception of a flat portion in which the light source is implemented. The flat portion represents a lens 26 for the light source. The lens 26 covers an opening that leads to an internal portion of the head unit 14. A bridge 28 extends across the opening and resides just behind the lens 26. The bridge 28 is generally thin to reduce light blockage. The bridge 28 widens at a central point to form a central pad 30, which has a top side and a bottom side. One or more LEDs 32 are mounted on the bottom side of the central pad 30, such that the light emitted from the LEDs 32 is initially directed toward the center of the head unit 14.

With particular reference to FIG. 6, a conical internal reflector 34 resides behind the lens 26, wherein a volume bounded by the lens 26 and the internal reflector 34 defines a mixing chamber 36. The light emitted from the LEDs 32 reflects off of the surface of the internal reflector 34, mixes in the mixing chamber 36, and exits the mixing chamber 36 through the lens 26. While the LEDs 32 are provided on the bottom side of the central pad 30 of the bridge 28 in this embodiment, the LEDs 32 can also be provided about the vertex of the internal reflector 34 and oriented to emit light toward the lens 26. Those skilled in the art will recognize other light source configurations. With a light source integrated into the head unit 14, the pan-tilt mechanism 12 is able to direct the beam of light emitted by the light source throughout an extensive range of motion.

Notably, the lighting fixture L may also be associated with one or more image sensors 38. As illustrated in FIGS. 5 and 6, an image sensor 38 may be mounted on the top surface of the central pad 30 of the bridge 28. As such, the pan-tilt mechanism 12 is also capable of positioning the image sensor 38 over an extensive range of motion. Notably, one or more image sensors 38 may be positioned outside of the light source and about the head unit 14 or the pan-tilt mechanism 12. The image sensors 38 could also be placed inside the mixing chamber 36 along the internal reflector 34. Further, modules that include image sensors 38 may be tethered to the lighting fixture L using appropriate cabling.

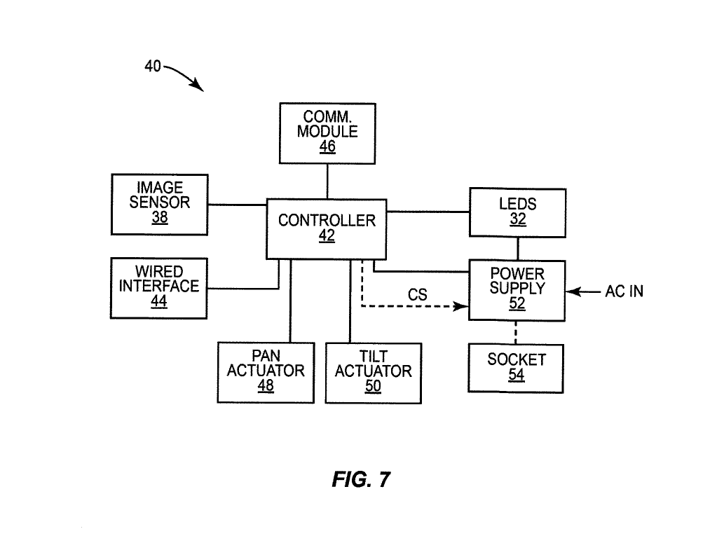

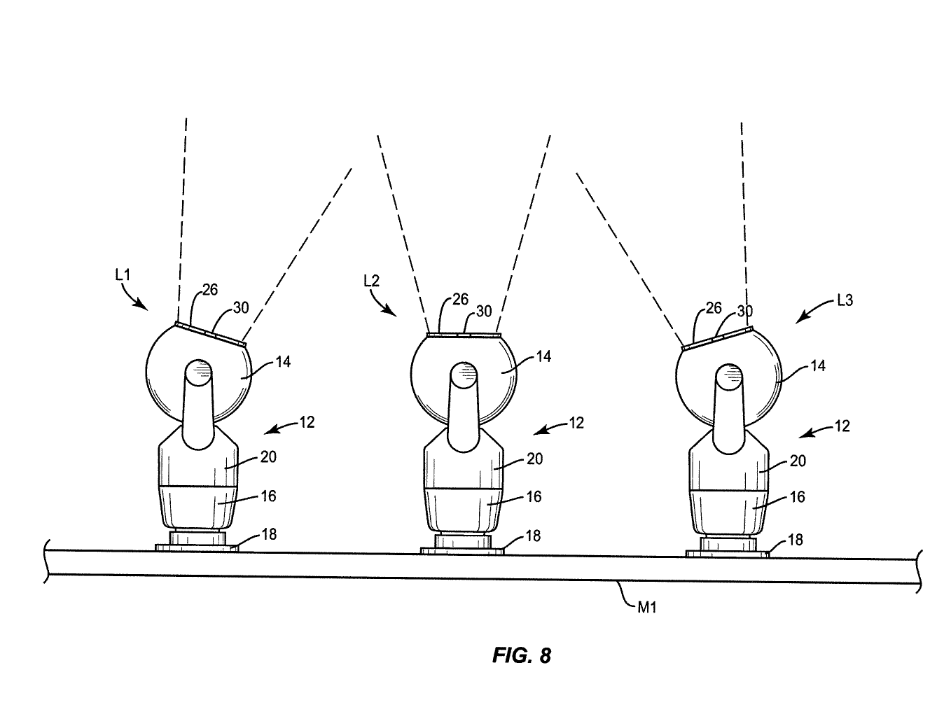

The lighting fixture L will include a control system 40 that is integrated into the pan-tilt mechanism 12. The LEDs 32 and the image sensors 38 are considered part of the overall control system 40 for the purposes of this description. With reference to FIG. 7, an exemplary control system 40 is illustrated. The control system 40 will include one or more controllers 42, which are capable of driving the LEDs 32 based on input from one or more of a wired interface 44, a communication module 46, the image sensors 38, or the like. The controller 42 is based on one or more application-specific integrated circuits, microprocessors, microcontrollers, or like hardware, which are associated with sufficient memory to run the firmware, hardware, and software necessary to impart the functionality described herein. Notably, not all of the LEDs 32 need to be used for creating the emitted light beam. One or more of the LEDs 32 may be used as a status indicator, which will be discussed further below. The LEDs 32 may range from a single LED to a plurality of the same or different colored LEDs. While LEDs are described, other light sources are possible.

The controller 42 is also capable of controlling a pan actuator 48 of the pan mechanism 20 and a tilt actuator 50 of the tilt mechanism 24. The pan actuator 48 controls the rotation of the pan mechanism 20 relative to the base 16. The tilt actuator 50 controls the rotation of the head unit 14 relative to the axis that extends between the tilt mechanisms 24.

The wired interface 44 may be used for a variety of purposes, which range from basic control of the light source (on, off, dimming) to controlling all aspects of the lighting fixture L, such pan-tilt control, programming, and the like. The communication module 46 provides a wireless interface, which may facilitate direct or indirect communications with the remote control RC, other lighting fixtures L, and network devices, such as gateways, routers, switches, remote control systems, personal computers, mobile telephones, and the like. Virtually any communication standard may be employed to facilitate such communications, including Bluetooth, IEEE 802.11 (wireless local area network (LAN)), near field, cellular, and the like wireless communication standards.

A power supply 52 is capable of converting incoming power to a format necessary for supplying the controller 42 and the other components of the control system 40. For example, the power supply 52 may include an AC-DC converter followed by a DC-DC converter, which cooperate to convert an AC power source to an intermediate DC level and then further convert the intermediate DC level to one or more other DC levels, which are required for supplying the controller 42 and the other components of the control system 40.

FIG. 8 illustrates three lighting fixtures L1, L2, and L3 mounted to a mounting track M1 to provide a track lighting configuration. As noted above, the lighting fixtures L need not be directly mounted to a mounting track M1; however, the mounting track M1 is often an effective mechanism for mounting a series of lighting fixtures L in an inverted manner from a ceiling in a direct or suspended fashion, as is often done with traditional track lighting systems. As such, the various lighting fixtures L may be oriented to direct emitted light in the same or different directions. As illustrated, each of the lighting fixtures L1, L2, and L3 have different orientations that cause the emitted light from each of the fixtures to be directed toward a common object, which is not shown.

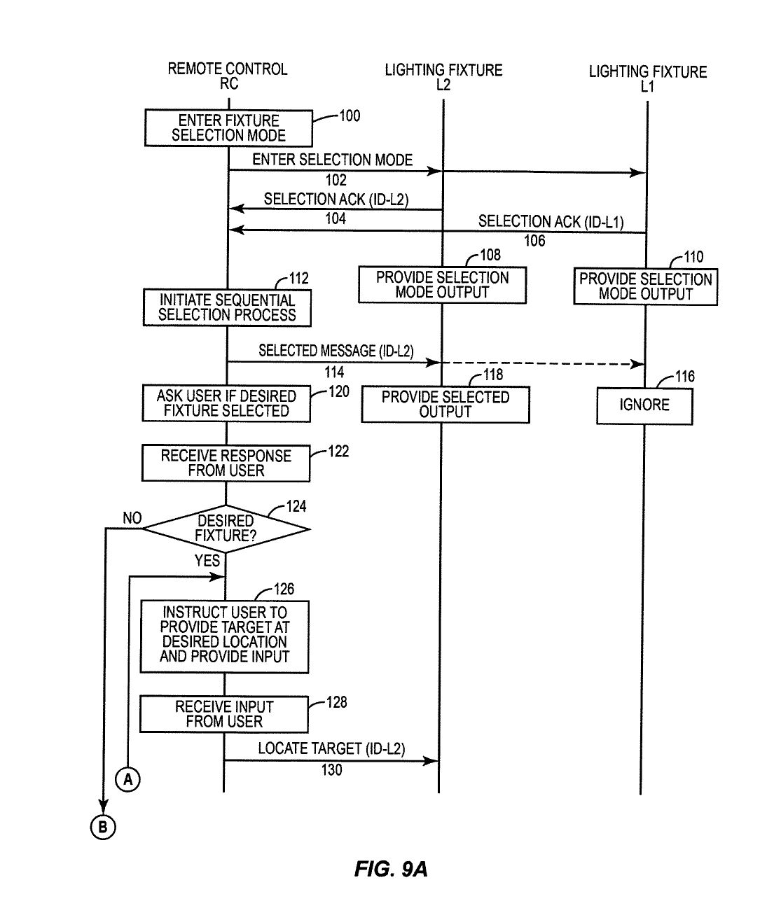

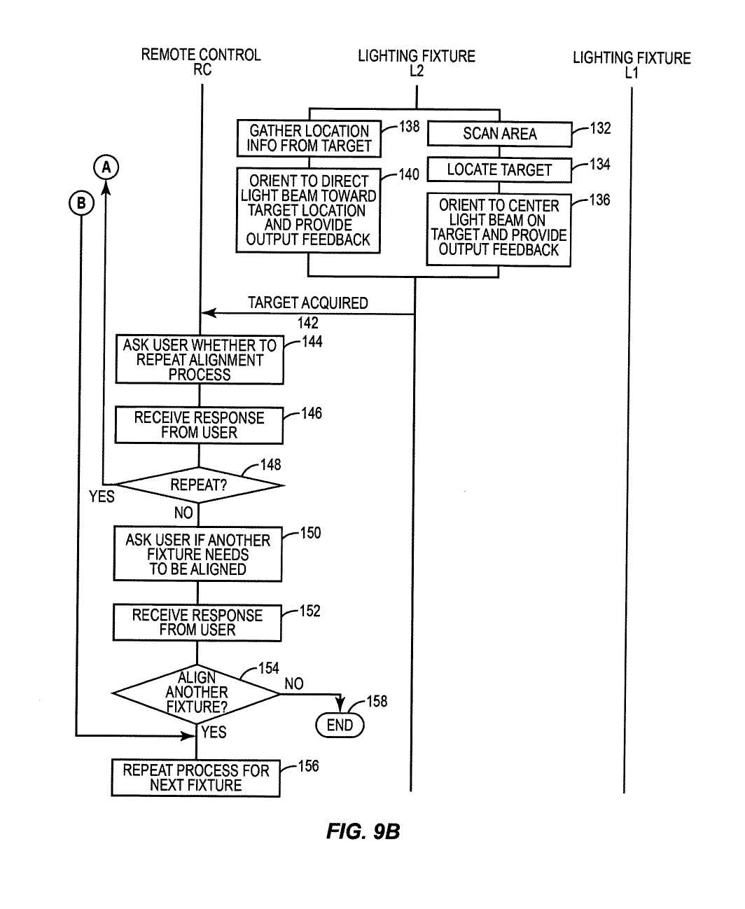

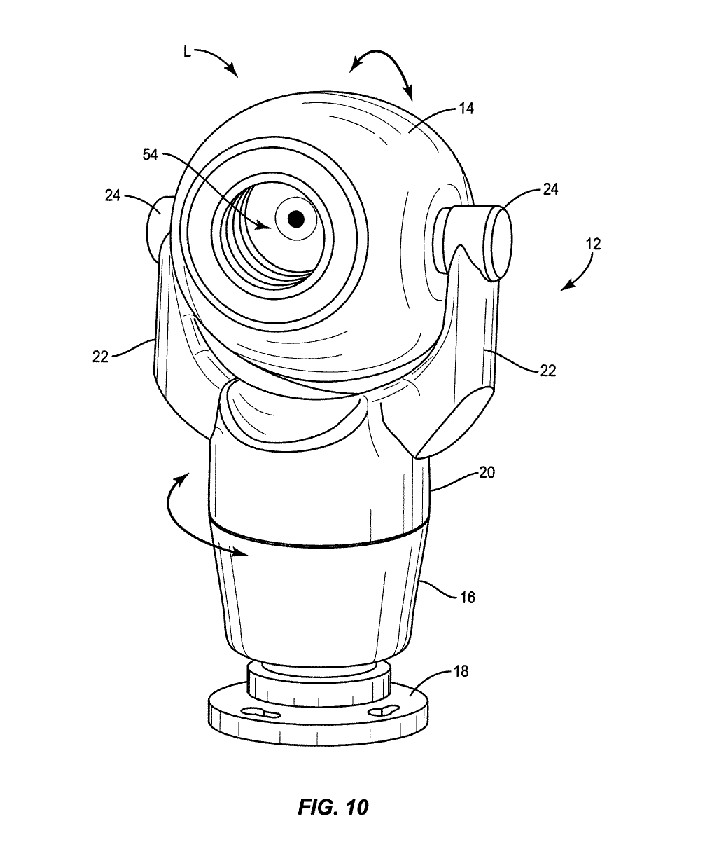

Turning now to FIGS. 9A and 9B, an exemplary process for selecting a lighting fixture L, providing a target, and reorienting the lighting fixture L to illuminate to the target is shown. For this example, assume that there are two lighting fixtures L1 and L2 that are in wireless communication with the remote control RC in a direct or networked (indirect) fashion.

Initially, a user will interact with the remote control RC to enter a fixture selection mode (step 100). The remote control RC will respond by sending a message to the lighting fixtures L1 and L2 to enter the selection mode (step 102). Both of the lighting fixtures L1 and L2 will enter the selection mode. In response, the lighting fixtures L1 and L2 will send a selection acknowledgment (ACK), which may include an ID for the respective lighting fixtures L1 and L2 (steps 104 and 106). The ID for lighting fixture L1 is referenced as ID-L1, and the ID for lighting fixture L2 is referenced as ID-L2.

Upon entering the selection mode, the lighting fixtures L1 and L2 will provide a selection mode output, which may entail controlling the light output in a fashion that is indicative of being in the selection mode (steps 108 and 110)). The light output may be dimmed, brightened, flashed, changed in color, changed in color temperature, or any combination thereof to indicate entry into the selection mode. Controlling the light output is meant merely to provide human perceptible feedback of being in the selection mode. Alternative feedback mechanisms could include controlling the output of a separate indicator LED or the like, which is not part of the group of LEDs that provide the primary light output.

Upon receipt of the selection acknowledgments, the remote control RC may initiate a sequential selection process (step 112). Initially, an order in which to orient the lighting fixture L1 and L2 is decided. For this example, lighting fixture L2, which is associated with ID-L2, is the first one chosen. As such, the remote control RC will send to the lighting fixtures L1 and L2 a selected message indicating that lighting fixture L2 (ID-L2) is selected (step 114). Since the selected message is intended for lighting fixture L2, lighting fixture L1 will ignore the message and remain in the selection mode (step 116).

Upon receiving the selected message, the lighting fixture L2 will provide a selected output, which may entail controlling the light output in a fashion that is indicative of lighting fixture L2 being selected (step 118). The light output that indicates lighting fixture L2 is selected may be different from the light output that indicates lighting fixture L2 is in selection mode. For example, the light output of lighting fixture L1 and L2 may blink off and then transition to a low output level upon entering the selection mode. Upon lighting fixture L2 being selected, the light output of lighting fixture L2 may blink off and transition to a high output level upon being selected. The light output of lighting fixture L1 will remain at the low output level, since it was not selected and remains in selection mode. Again, alternative indicators may be provided.

During this time, the remote control RC may ask the user if the desired lighting fixture L2 was selected in response to initiating the sequential selection process (step 120). When the remote control RC receives a response from the user (step 122), the remote control RC will determine whether the desired lighting fixture L2 is selected (step 124). If the desired lighting fixture was not selected, the process may be repeated.

Assuming the user wanted to select lighting fixture L2, the remote control RC will instruct the user to provide a target at the desired location to illuminate, and provide an input, such as selecting a specified button, when the target is at the desired location (step 126). Upon receiving the input from the user (step 128), the remote control RC will transmit to the selected lighting fixture L2 (ID-L2) an instruction to locate the target (step 130).

As noted above, each lighting fixture L may be configured to either scan an area to identify a target through appropriate sensors or gather location information from a target. In the latter case, the location information may be a specific location (i.e. actual coordinates) or a signal from which a relative location can be determined (i.e. triangulation). For a scanning embodiment, the selected lighting fixture L2 will scan an area for the target (step 132), locate the target (step 134), and orient itself to direct the center of the light beam emitted from the lighting fixture L2 on the target (step 136). Once reoriented, the lighting fixture L2 may provide output feedback, such as returning to normal light output levels, flashing, or the like (step 136).

For the target scanning embodiment, the controller 42 of the lighting fixture L2 may employ the pan-tilt mechanism 12 in a manner that scans the field of view for the image sensor 38 throughout an available coverage area for the lighting fixture L2. While scanning, the controller 42 will process the image information received from the image sensor 38 to identify the target. Once the target is identified, the controller 42 will adjust the pan-tilt mechanism 12 to center the light beam emitted from the lighting fixture L2 on the target. If the center of the light beam corresponds with the center of the field of view of the image sensor 38, orienting the lighting fixture L2 may simply include adjusting the pan-tilt mechanism 12 to a position where the target is centered in the field of view of the image sensor 38. If the center of the light beam is offset from the center of the field of view for the image sensor 38, the offset may be taken into consideration when positioning the pan-tilt mechanism 12. Alternatively, the controller 42 may monitor both the target and the light beam emitted from the lighting fixture L2 and adjust the pan-tilt mechanism 12 to a point where the center of the light beam aligns with the target, regardless of the position of the target within the field of view of the image sensor 38.

For the location-gathering embodiment, the controller 42 of lighting fixture L2 may gather location information from information transmitted from the target (step 138). Again, the target in this embodiment may be the remote control RC, which is held in the location to be illuminated. The remote control RC is then used to transmit a location signal that either includes the actual location of the remote control RC or from which the location of the remote control RC may be determined by the lighting fixture L2 or collectively by the lighting fixtures L1 and L2. Upon determining the location of the target, the controller 42 will control the pan-tilt mechanism 12 to direct the light beam toward the target location (step 140). Once reoriented, the lighting fixture L2 may provide output feedback, such as returning to a normal light output level, flashing, or the like (step 140).

Once the lighting fixture L2 has reoriented itself, a message is sent back to the remote control RC to indicate that the target was acquired and reorientation is complete (step 142). At this point, the remote control RC may ask the user whether to repeat the alignment process for the selected lighting fixture L2, in case the orientation of the lighting fixture L2 needs to be adjusted (step 144). The remote control RC will receive the user's response (step 146), and determine whether to repeat the alignment process (step 148). If the user desires to repeat the alignment process for the lighting fixture L2, the process will return to step 126, wherein the remote control RC will instruct the user to provide the target at a new location.

If there is no need to repeat the alignment process for the lighting fixture L2, the remote control RC will ask the user if another lighting fixture L, such a lighting fixture L1, needs to be aligned (step 150) and will wait a response from the user (step 152). If no other lighting fixtures L need to be aligned (step 154), the process ends (step 158). If other lighting fixtures L need to be aligned (step 154), the above process is repeated for the next fixture (step 156). For example, the lighting fixture L1 could be selected and reoriented next using the same process as described for lighting fixture L2.

In the above example, a lighting fixture L is selected by a process of gathering information from all of the lighting fixtures L in a selection mode and then instructing one lighting fixture L at a time to provide a visible indication of being active. The user can accept selection of the lighting fixture when the lighting fixture becomes active. Alternatively, each lighting fixture L may have a button that can be pressed to enter orientation mode such that selection of the lighting fixtures L to be oriented is manual. Another selection technique may involve near-field communications, wherein the selection process requires the user to hold the remote control RC very close to the lighting fixture L to be selected. Only the lighting fixture or fixtures L that pick up the near-field (very short range) communication are selected for orientation.

Yet another option is to project a specified light signal from the remote control RC at the image sensor 38 of the desired lighting fixture L. The lighting fixture L will detect the light signal and initiate the scanning process. The light signal will likely be different from that used to project a target. The light signal may be a focused beam, such as that provided by a laser pointer, and pulsed repeatedly according to a fixed pattern. The fixed pattern is detected by the lighting fixture L and is indicative of the need to initiate the scanning process.

Upon recognizing the need to initiate the scanning process, the lighting fixture L may blink to indicate that the light signal was received and give the user a set time period to project the target at the desired location. After the time period has expired, the lighting fixture L will scan for the target, and if the target is relatively stationary for a set period of time, orient the lighting fixture L such that the emitted light is directed toward the target.

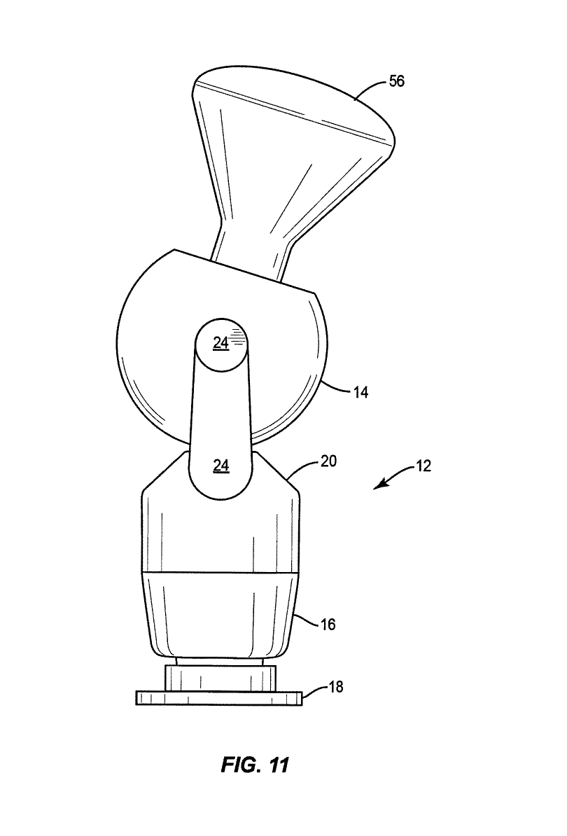

With reference to FIGS. 10 and 11, the lighting fixture L need not have an integrated light source. Instead, the lighting fixture L may include a socket 54 that is configured to receive a base of a standard light bulb 56 (shown only in FIG. 11). As shown in FIG. 10, the socket 54 is threaded and configured to receive a standard Edison-style base. However, any type of socket 54 may be used. In such an embodiment, the lighting fixture L will operate as described above with the exception that the integrated LED-based light source is effectively replaced with the socket 54, which allows standard bulbs to be used and replaced as necessary. With reference back to FIG. 7, the controller 42 may be configured to control the power provided to the socket 54 by controlling one part of the power supply 52, and as such, control turn on, turn off, and dimming of the light bulb 56 that is mounted in the socket 54 with control signal CS.

Alternatively, the AC input may be directed directly to the socket 54, wherein the AC input will be on, off, or dimmed at a desired level using traditional dimmer technology. Power is supplied to the control system 40 when the AC input is provided in a full-on or dimmed state, but not provided when the AC input is not provided in the off state. Those skilled in the art will recognize other configurations upon understanding this disclosure.

For embodiments with an integrated light source or receiving a standard light bulb 56, the state of the output may be controlled by the controller 42 in response to input received via the communication module 46, wired interface 44, remote control RC, or associated environmental sensors, such as ambient light, occupancy, or temperature sensors. The state of the output may relate to the light output being on, off, or dimmed to a desired dimming level as well as the color or color temperature of the light output.

Image sensors 38 may be placed virtually anywhere on the lighting fixture L if so desired. For example, multiple image sensors 38 could be evenly distributed about the socket 54 on the head unit 14, pan mechanism 20, base 16, or any combination thereof. One should take into consideration how the light bulb 56 will affect the field of view of the various image sensors 38. Notably, image sensors 38 or the like need not be provided on the lighting fixture L. This is particularly applicable when the lighting fixture L is configured to gather and respond to location information as opposed to scanning an area to identify the target and redirecting the emitted light beam at the target.

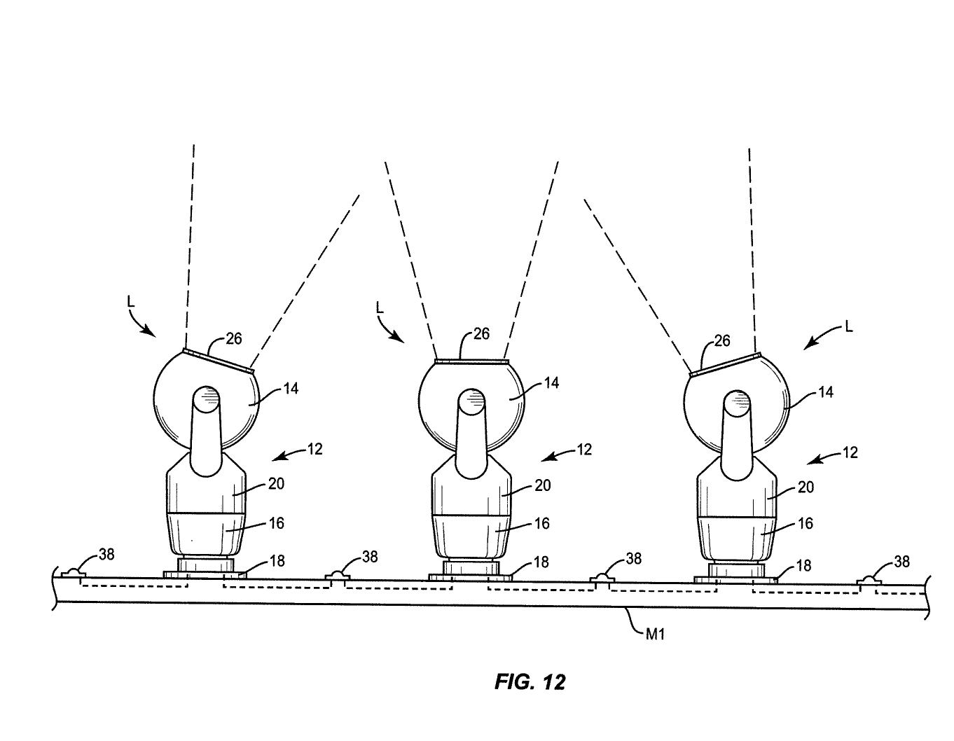

Turning now to FIG. 12, an alternative embodiment is shown wherein the image sensors 38 are not physically attached to or integrated in the lighting fixtures L. Instead, the image sensors 38 are mounted apart from the lighting fixtures L, and as illustrated, mounted on the mounting track M1. As such, the image sensors 38, and their respective fields of view, are fixed and do not move with movement of the head unit 14. Each image sensor 38 may be configured to serve one or more lighting fixtures L. The image sensors 38 may be coupled to the control system 40 through an appropriate interface, such as the wired interface 44, communication module 46, or the like. Further, power may be provided to the image sensors 38 via the power supply 52 of the lighting fixtures L.

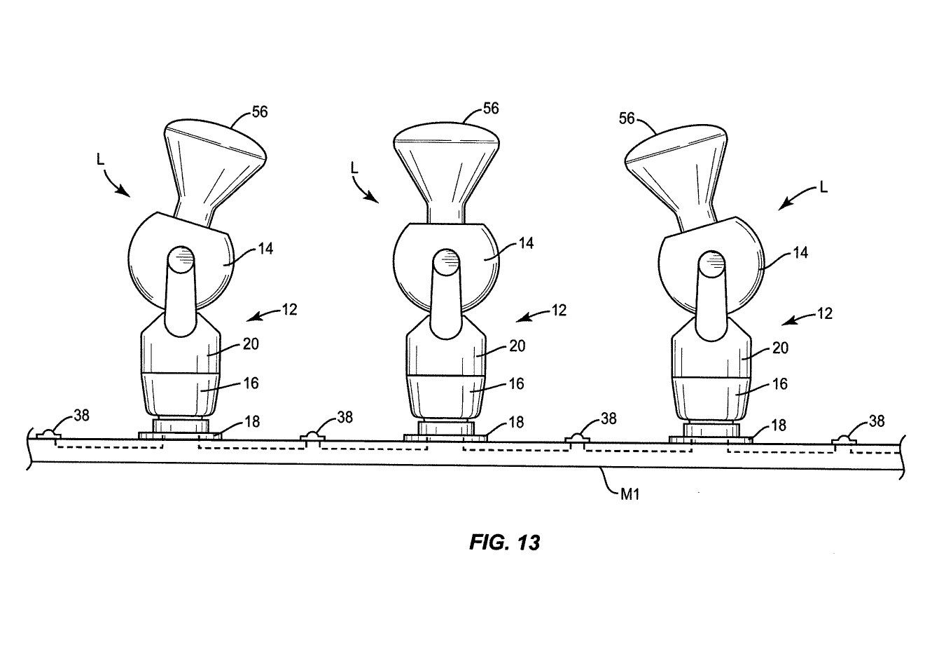

In operation, the controller 42 of the control system 40 for each lighting fixture L is able to identify a target from the information provided by the image sensors 38 and reorient the selected lighting fixture L such that the emitted light beam is directed toward the target. This may be accomplished by monitoring both the projected light beam and the target, and orienting the lighting fixture L such that the center of the emitted light beam substantially aligns with the target. While FIG. 12 illustrates an embodiment wherein the light sources are integrated within the head unit 14, FIG. 13 illustrates an embodiment wherein the head unit 14 includes a socket 54, which is configured to receive a light bulb 56. Other than the difference in the type of light source, operation of the lighting fixtures L for these embodiments is substantially the same.

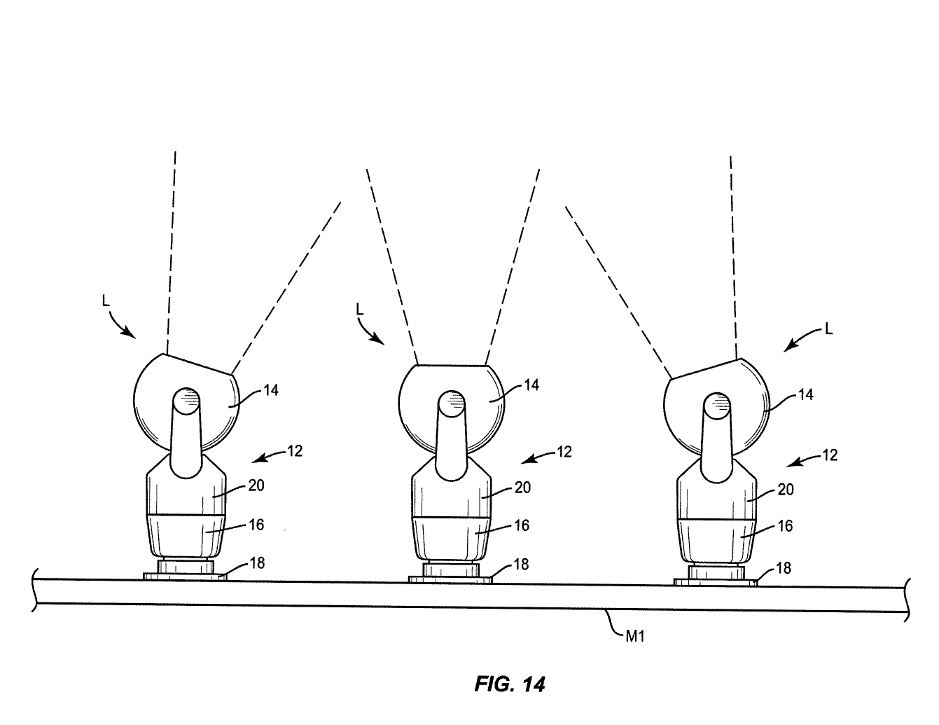

FIG. 14 shows an embodiment wherein there are no image sensors 38, and each of the lighting fixtures L is capable of wirelessly receiving from the remote control RC or other appropriate device a signal that either includes location information or from which location information can be derived. In this instance, each of the lighting fixtures L, once selected, is capable of using the location information to reorient itself to direct the emitted light beam toward a location associated with the location information.

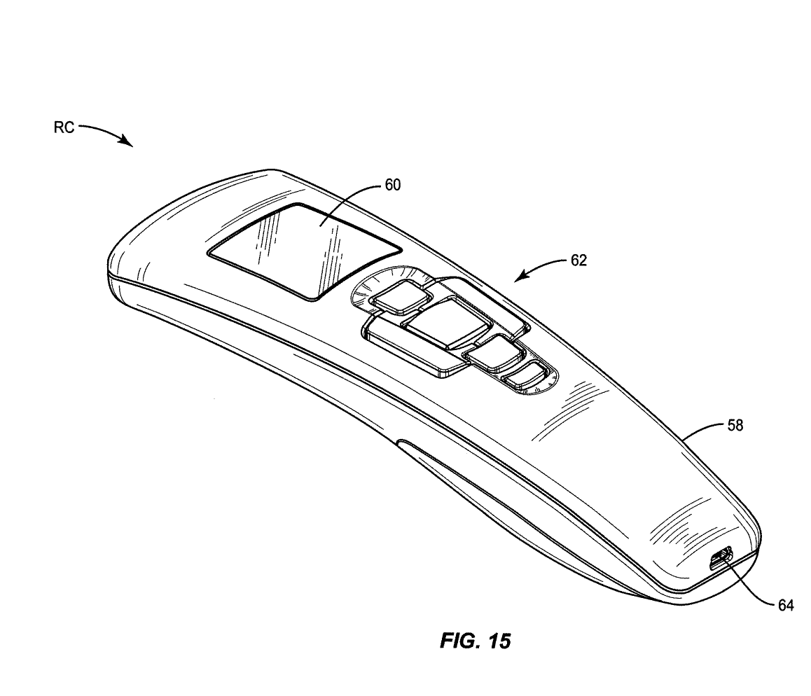

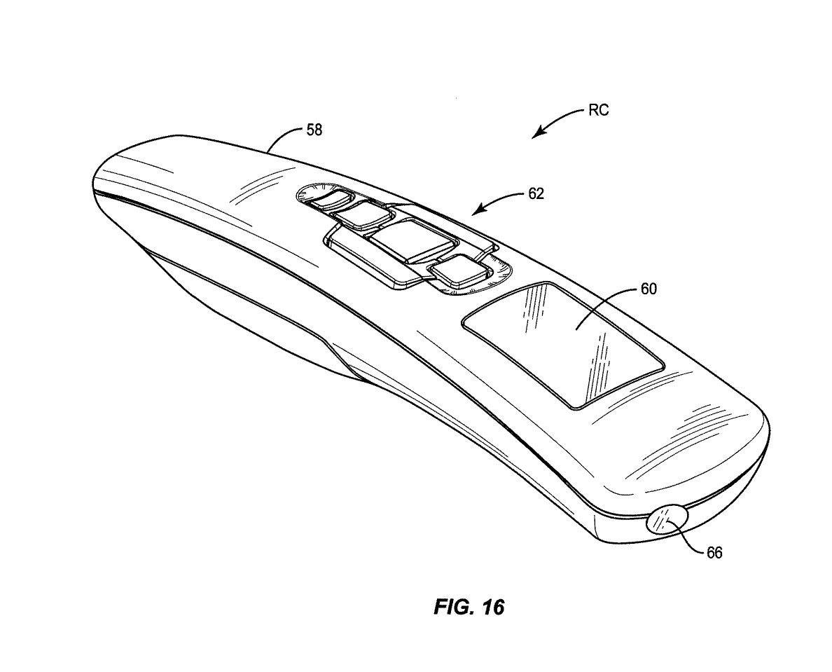

With reference to FIGS. 15 and 16, an exemplary remote control RC is illustrated. The remote control RC includes a housing 58 in which a display 60 and user buttons 62 are integrated. The display 60 may be configured as a touch screen device, wherein all or a portion of the user buttons 62, or like input mechanisms, are effectively integrated with the display 60. A power and communication port 64 is shown on one end of the housing 58 in FIG. 15, and a projection output port 66 is shown on the opposite end of the housing 58 in FIG. 16. The projection output port 66 is the mechanism from which the target may be projected. The electronics of the remote RC are described below.

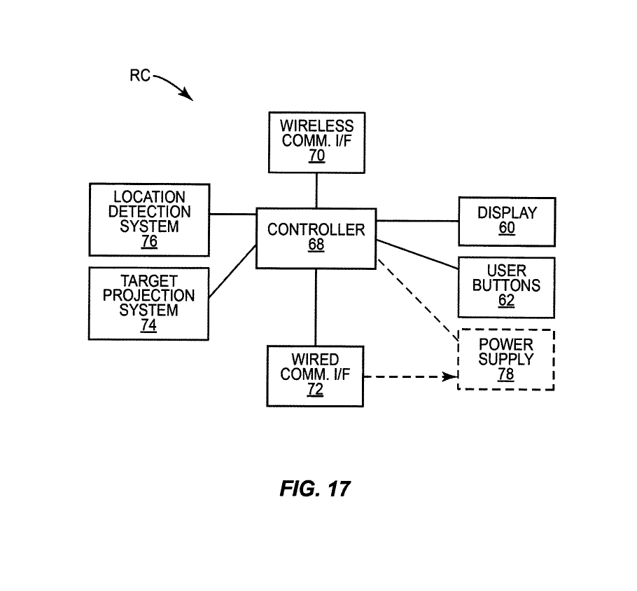

With reference to FIG. 17, electronics for the remote control RC may include a controller 68 that is associated with a wireless communication interface 70, a wired communication interface 72, a target projection system 74, location detection system 76, display 60, and the user buttons 62. The controller 68 is based on one or more application-specific integrated circuits, microprocessors, microcontrollers, or like hardware, which are associated with sufficient memory to run the firmware, hardware, and software necessary to impart the functionality described herein.

Everything may be powered by a power supply 78, which may include a battery and any necessary DC-DC conversion circuitry to convert the battery voltage to the desired voltages for powering the various electronics. The display 60 and user buttons 62 provide a user interface that displays information to the user and allows a user to input information to the remote control RC.

The wireless communication interface 70 facilitates wireless communications with the lighting fixtures L directly or indirectly via an appropriate wireless network. The wireless communication interface 70 may also be used to facilitate wireless communications with a personal computer, wireless network (WLAN), and the like. Virtually any communication standard, may be employed to facilitate such communications, including Bluetooth, IEEE 802.11 (wireless LAN), near field, cellular, and the like wireless communication standards. The wired communication interface 72 may be used to communicate with a personal computer, wired network (LAN), lighting fixtures L, and the like. In certain embodiments, the wireless communication interface 70 is capable of transmitting a location signal from which one or more lighting fixtures L are able to determine the location of the remote control RC relative to the lighting fixtures L. As noted above, the location of the remote control RC may be used by the lighting fixtures L to determine how to orient their light output.

In other embodiments, the target projection system 74 is provided. The target projection system 74 may take various forms, ranging from a laser or light emitting diode to an image projector that uses a laser, bulb, or other appropriate light source to project light through an image panel to project the target. Alone, or in combination with the projection output port 66, the target projection system 74 is able to project a fixed or variable target onto a variety of surfaces. The projected image represents a target, which is could simply be a dot, circle, crosshair pattern or like symbol to a complex image, pattern, or machine readable code, such as a bar code or matrix code. The projected target may also be projected to have a defined color, color temperature, or the like, which may aid in allowing the lighting fixture L to identify the target. The goal of the target projection system 74 is to allow the remote control RC to project a target, which is readily identifiable by the lighting fixture L.

In other embodiments, the remote control RC may include the location detection system 76, which may include a global positioning system (GPS) receiver, one or more accelerometers, or a combination thereof to help identify a specific location of the remote control RC. The location of the remote control RC may be sent to the lighting fixtures L, which will orient their light outputs toward the location.

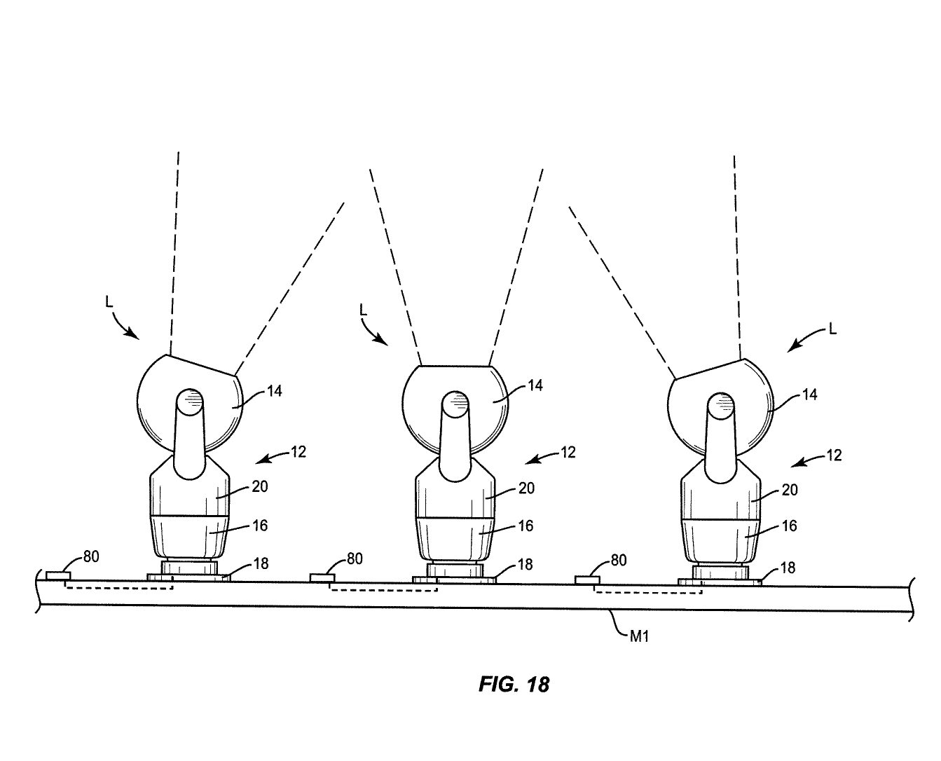

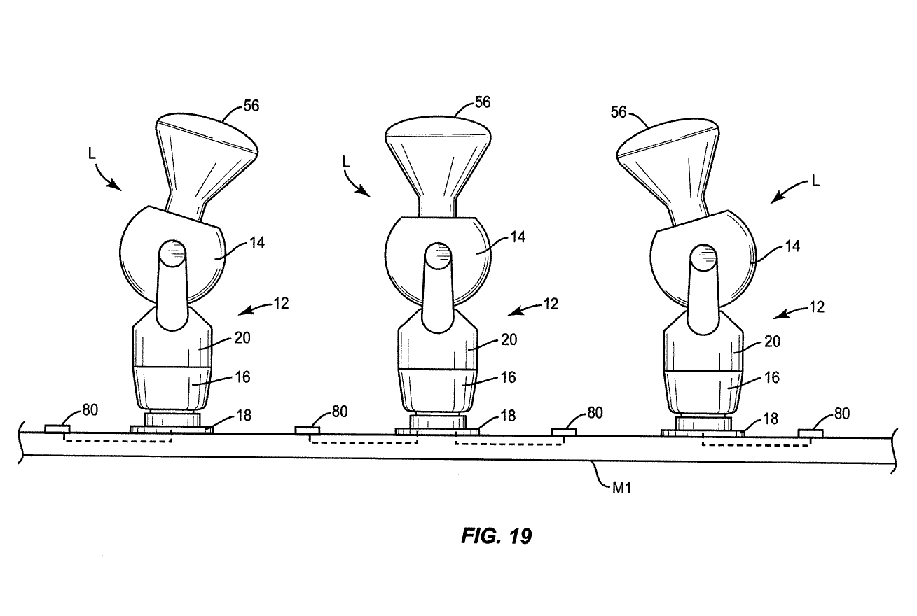

FIGS. 18 and 19 illustrate embodiments where the lighting fixtures L are mounted on a mounting track M1 along with various receivers 80, which are capable of receiving light, acoustic, or radio frequency signals. The receivers 80 are effectively antennas or sensors for the given type of signals being transmitted. The receivers 80 may be an extension of the wireless communication interface 70 or coupled to the lighting fixtures L through the wired interface 44. In an embodiment in which the lighting fixtures L are capable of receiving a signal from the remote control RC and determining the location of the remote control RC based on the signal, the receivers 80 may be positioned at defined locations along the mounting track M and used to facilitate triangulation or the like. In essence, the respective lighting fixtures L are capable of receiving the signal from the remote control RC via each receiver 80. The only difference between the embodiments of FIGS. 18 and 19 is the type of light source employed by the lighting fixtures L.

As will be appreciated by those skilled in the art, the difference in times at which the signal is received in each receiver 80, in combination with the known locations of the receivers 80, may allow the lighting fixtures L to determine the relative location of the remote control RC. During this process, the lighting fixtures L may communicate with each other to share the timing information for receiving the signal. Each lighting fixture L may determine the relative location of the remote control RC based on the timing information from all of the receivers. Alternatively, the timing information may be sent to one lighting fixture L, which will determine the relative location of the remote control RC and share that location information with the other lighting fixtures L. Notably, the lighting fixtures L from different mounting tracks M1 may communicate with each other for various reasons, including sharing location information, timing information, control information, or the like. In fact, the various lighting fixtures L may form part of a mesh network, as described and U.S. patent application Ser. No. 13/782,022, filed Mar. 1, 2013; Ser. No. 13/782,040 filed Mar. 1, 2013; Ser. No. 13/782,053 filed Mar. 1, 2013; Ser. No. 13/782,068 filed Mar. 1, 2013; Ser. No. 13/782,078 filed Mar. 1, 2013; Ser. No. 13/782,096 filed Mar. 1, 2013; Ser. No. 13/782,131 filed Mar. 1, 2013; and Ser. No. 13/868,021 filed Apr. 22, 2013, which are incorporated herein by reference in their entireties.

Notably, the embodiment of FIG. 18 provides one receiver 80 for each lighting fixture L. The embodiment of FIG. 19 provides multiple receivers 80 for one or more lighting fixtures L. In yet another embodiment, multiple receivers 80 may be shared by one or more lighting fixtures L, in a fashion similar to that illustrated for the image sensors 38 of FIG. 13.

Those skilled in the art will recognize improvements and modifications to the preferred embodiments of the present disclosure. All such improvements and modifications are considered within the scope of the concepts disclosed herein and the claims that follow.

What is claimed is:

1. A lighting fixture comprising:
a motorized pan-tilt mechanism with a head unit that includes either a light source or a socket adapted to receive a light source, wherein the motorized pan-tilt mechanism is capable of orienting the head unit to control a direction in which light emitted from the light source is directed; and
a controller associated with at least one sensor and the motorized pan-tilt mechanism, and for an orientation process, configured to:
receive sensor information from the at least one sensor that is in communication with the controller;
identify a target based on the sensor information; and
control the motorized pan-tilt mechanism to orient the head unit such that the light emitted from the light source is directed at the target.

2. The lighting fixture of claim 1 wherein the light source is integrated into the head unit.

3. The lighting fixture of claim 1 wherein the light source is a light bulb with a base and the head unit includes the socket, which is configured to receive the light bulb.

4. The lighting fixture of claim 1 wherein the motorized pan-tilt mechanism further includes a base that is coupled to the head unit.

5. The lighting fixture of claim 4 wherein the base is configured to control at least panning of the head unit.

6. The lighting fixture of claim 1 wherein the at least one sensor is mounted apart from the lighting fixture and in communication with the controller via an interface.

7. The lighting fixture of claim 1 further comprising the at least one sensor and wherein the at least one sensor is mounted on the motorized pan-tilt mechanism and moves in conjunction with either the light source or the socket when the head unit is moved.

8. The lighting fixture of claim 7 wherein to identify the target based on the sensor information, the controller is configured to:
move the head unit;
monitor the sensor information for the target as the head unit is moved; and
locate the target in the sensor information.

9. The lighting fixture of claim 8 wherein to control the motorized pan-tilt mechanism to orient the head unit such that the light emitted from the light source is directed at the target, the controller determines an orientation for the head unit such that the light emitted from the light source will be directed at the target based on the sensor information.

10. The lighting fixture of claim 8 wherein:
to identify the target based on the sensor information, the controller is further configured to monitor the sensor information for the light emitted from the light source, and
to control the motorized pan-tilt mechanism to orient the head unit such that the light emitted from the light source is directed at the target, the controller is configured to orient the head unit such the light emitted from the light source aligns with the target based on the sensor information.

11. The lighting fixture of claim 1 wherein prior to the orientation process, the controller is further configured to:
receive selection initiation information from a remote entity; and
receive selection information indicative of the lighting fixture being selected from the remote entity.

12. The lighting fixture of claim 11 further comprising a communication interface and wherein the selection initiation information and the selection information are received via the communication interface.

13. The lighting fixture of claim 12 wherein the communication interface is a wireless communication interface.

14. The lighting fixture of claim 12 wherein the communication interface is a wired communication interface.

15. The lighting fixture of claim 12 wherein the selection information comprises an identifier of the lighting fixture.

16. The lighting fixture of claim 15 wherein the controller is further configured to provide the identifier of the lighting fixture to the remote entity in response to receiving the selection initiation information.

17. The lighting fixture of claim 11 wherein the controller is further configured to provide human perceptible feedback in response to receiving the selection information.

18. The lighting fixture of claim 17 wherein the human perceptible feedback is provided by controlling the light emitted by the light source in a defined manner.

19. The lighting fixture of claim 17 further comprising an indicator that is separate from the light source and wherein the human perceptible feedback is provided by controlling the indicator in a defined manner.

20. The lighting fixture of claim 11 wherein the controller is further configured to provide human perceptible feedback in response to receiving the selection initiation information.

21. The lighting fixture of claim 20 wherein the human perceptible feedback is provided by controlling the light emitted by the light source in a defined manner.

22. The lighting fixture of claim 20 further comprising an indicator that is separate from the light source and wherein the human perceptible feedback is provided by controlling the indicator in a defined manner.

23. The lighting fixture of claim 11 wherein:
the selection information comprises an identifier of the lighting fixture;
the controller is further configured to:
in response to receiving the selection initiation information, provide the identifier of the lighting fixture to the remote entity and provide first human perceptible feedback;
in response to receiving the selection information, provide second human perceptible feedback, wherein the first and second human perceptible feedback are provided by controlling the light emitted by the light source in a defined manner.

24. The lighting fixture of claim 1 wherein prior to the orientation process, the controller is further configured to receive a signal from a remote entity via the at least one sensor, the signal indicative of the lighting fixture being selected.

25. The lighting fixture of claim 24 wherein the at least one sensor is an image sensor.

26. The lighting fixture of claim 1 wherein the at least one sensor is an image sensor.

27. A lighting fixture comprising:
a motorized pan-tilt mechanism with a head unit that includes either a light source or a socket adapted to receive a light source, wherein the motorized pan-tilt mechanism is capable of orienting the head unit to control a direction in which light emitted from the light source is directed;
a communication interface; and
a controller associated with the communication interface and the motorized pan-tilt mechanism, and for an orientation process, configured to:
receive a signal via the communication interface, the signal bearing on a location of a target to be illuminated;
determine a desired orientation for the head unit where the light emitted from the light source is directed toward the target; and
control the motorized pan-tilt mechanism to orient the head unit at the desired orientation.

28. The lighting fixture of claim 27 wherein the signal includes location information that identifies a location associated with the target and the controller determines the desired orientation based on the location associated with the target.

29. The lighting fixture of claim 27 wherein the controller derives a location associated with the target based at least in part on a characteristic of the signal and determines the desired orientation based on the location associated with the target.

30. The lighting fixture of claim 29 wherein the controller derives the location of the target using triangulation.

31. The lighting fixture of claim 27 wherein the light source is integrated into the head unit.

32. The lighting fixture of claim 27 wherein the light source is a light bulb with a base and the head unit includes the socket, which is configured to receive the light bulb.

33. The lighting fixture of claim 27 wherein the motorized pan-tilt mechanism further includes a base that is coupled to the head unit.

34. The lighting fixture of claim 33 wherein the base is configured to control at least panning of the head unit.
